(19) United States
(12) Patent Application Publication
(10) Pub. No.: US 2004/0081874 A1
(43) Pub. Date: Apr. 29, 2004

(54) System comprising a fuel cell and a heat exchanger

(75) Inventors: Joachim Tachtler, Ismaning (DE); Franz-Josef Wetzel, Gernlinden (DE); Bernhard Edlinger, Augsburg (DE)

Correspondence Address: CROWELL & MORING LLP, INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 10/684,701

(22) Filed: Oct. 15, 2003

Related U.S. Application Data
(63) Continuation of application No. PCT/EP02/03708, filed on Apr. 3, 2002.

(30) Foreign Application Priority Data
May 4, 2001 (DE) 101 21 666.1

(51) Int. Cl. H01M 8/04

(52) U.S. Cl. 429/26

(57) ABSTRACT

A system includes a fuel cell, and a heat exchanger coupled to the fuel cell. The heat exchanger is arranged upstream of the fuel cell in a flow of gaseous reactants for the fuel cell for preheating gaseous reactants and downstream of the fuel cell in a flow of at least a portion of the waste gas from the fuel cell. The heat exchanger is directly integrated with the fuel cell so that there is a direct flow transition from the heat exchanger to the flow cell.

### CROSS REFERENCE TO RELATED APPLICATIONS

The present application is a continuation of International Patent Application No. PCT/EP02/03708, filed Apr. 3, 2002, designating the United States of America and published in German as WO 02/091509 A2, the entire disclosure of which is incorporated herein by reference. Priority is claimed based on Federal Republic of Germany Patent Application No. 101 21 666.1, filed May 4, 2001.

### SUMMARY OF THE INVENTION

The invention relates to a system comprising a fuel cell and a heat exchanger.

Especially in the case of high-temperature fuel cells, the reactants, which are to be brought into the fuel cell, such as the reaction air, must be preheated in order to bring them to their reaction temperature. This preheating takes place generally in a separate heat exchanger, in which, depending on the construction, a burner may also be integrated. Such a separate component, as well as the flow connections between the heat exchanger and the fuel cell, can attain a complexity comparable to that of the fuel cell, occupies space and adds additional weight.

It is an object of the present invention to improve this type of system that includes a fuel cell and a heat exchanger in such a manner that the system as a whole can be simplified. As a result, a reduction in costs is possible. In particular, a reduction in the space required and in the weight, as well as an improvement in the functioning, are possible.

Accordingly, it is an inventive concept to combine the heat exchanger and the fuel cell with one another and, moreover, in such a manner that the heat exchanger is disposed directly at, and integrated with, the fuel cell. With that, a direct flow transition from the heat exchanger to the fuel cell can be achieved. The supply of heat over the whole surface of the stack can be ensured directly. As a result of this coupling, space is saved and the weight is reduced, since an additional housing, pipeline systems and other structural devices, such as a so-called manifold, can be omitted. In accordance with a preferred embodiment, the heat exchanger may be constructed as a simple plate heat exchanger. Depending on the configuration of the heat exchanger, the supply of air can be improved in comparison to a heat exchanger with a manifold. Moreover, to increase the preheating of the air, it is possible to equip the heat exchanger additionally with a burner, so that the residual gas from the fuel cell can be subjected to an afterburning process. Due to the successful combustion in the heat exchanger/burner, this residual energy is then also, at least partly, supplied to the reactants, which are to be heated. Preferably, air or oxygen is used for this purpose.

Other objects, advantages and novel features of the present invention will become apparent from the following detailed description of the invention when considered in conjunction with the accompanying drawings.

### BRIEF DESCRIPTION OF THE DRAWINGS

FIG. 1 diagrammatically shows the construction of an inventive system, comprising a fuel cell and a heat exchanger and

FIG. 2 diagrammatically shows the construction of a conventional system comprising a fuel cell and a heat exchanger.

### DETAILED DESCRIPTION OF THE DRAWINGS

The construction shown in FIG. 2 is known from the state-of-the-art. A fuel cell 10, which has a stack with a plurality of individual cells 12, which are disposed parallel to one another, is supplied with gaseous reactants, predominantly with a fuel gas, indicated by the arrow 24, and air, indicated by the arrow 22.

Especially in the case of a high-temperature fuel cell (such as an SOFC fuel cell), the air must be brought to its reaction temperature, that is, must be preheated. For this purpose, a heat exchanger 14 is connected upstream, to which air is made available (see arrow 20) over a blower 18, which is shown only diagrammatically, in an intake port 16. As it flows through the heat exchanger 14, the air is heated to its operating temperature.

The heat exchanger 14 obtains the heat, necessary for heating the air, from the waste gasses of the fuel cell 10, which, marked with the arrow 24, are passed downstream from the individual cells 12 also through the heat exchanger 14 and subsequently discharged to the surrounding air, marked with the arrow 28. In addition, the residual fuel gas, marked with the arrow 26, is also supplied to the heat exchanger. At the same time, the heat exchanger 14 is constructed as a burner, so that unconsumed reactants (air, fuel gas) can be subjected to an afterburning treatment in the heat exchanger/burner 14. This additional energy is also used to heat the air.

Due to the conventional construction, with a separate heat exchanger and a separate fuel cell, as well as with additional pipelines, symbolized here by the arrows 22, 24 and 26, the system becomes relatively complex, heavy and expensive. Moreover, air-distributing systems (so-called manifolds) are required at the inlet and also at the outlet of the fuel cell

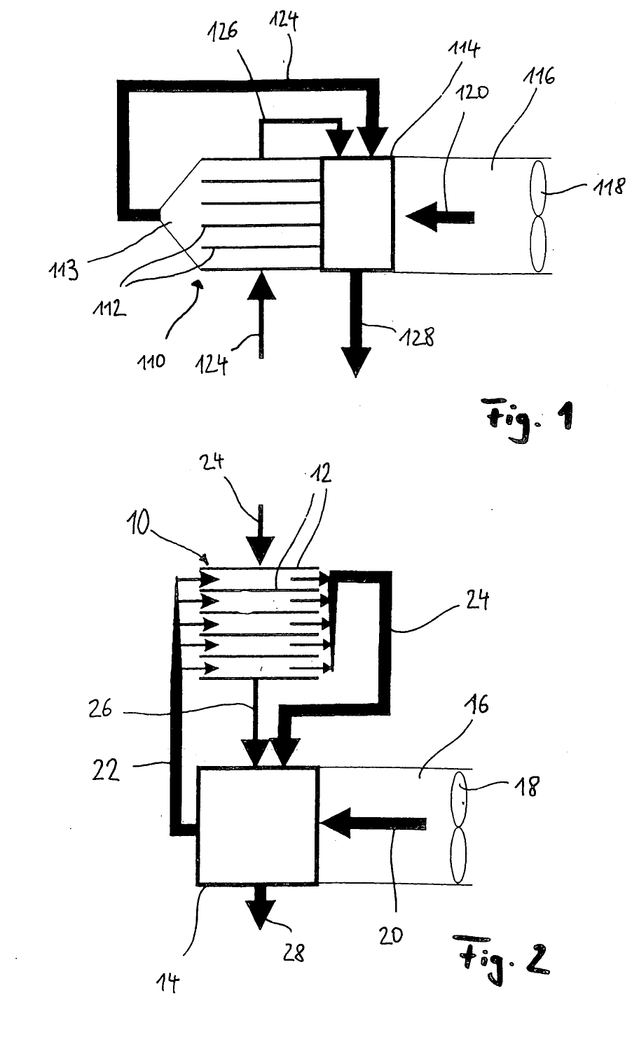

It is an object of the present invention to integrate the fuel cell and the heat exchanger. This is shown in FIG. 1. The fuel cell 110 once again has a plurality of individual cells 112, which are disposed parallel to one another and through which fuel gas 124 and air 120 flow. Due to a reaction between these two reactants, a currrent flow is generated in the fuel cell 110 in a known manner. Inventively, a heat exchanger 114 is now disposed directly in front of the stack with the individual cells 112 in such a manner, that the air 120, aspirated by means of a blower 118 over an intake passage 116, is passed uniformly through the heat exchanger 114 and, distributed over the stack, is brought into the fuel cell 110. With that, neither an additional pipeline between the heat exchanger 114 and the fuel cell 110 nor a manifold, connected upstream from the fuel cell 110, is required.

The residual air 124, discharge from the fuel cell 110 over a funnel 113, is returned to the heat exchanger 114 as much as possible without any detours. In-addition, the fuel gases 126, which have not yet been combusted, are also returned to the heat exchanger. As in the example of FIG. 2, the heat exchanger 114 has an integrated burner, with which the unconsumed reactants of air and fuel gas can be subjected to an afterburning treatment. The waste gasses from the heat exchanger/burner 114 are discharged to the surroundings (arrow 128).

With the present invention, it is possible to reduce the space required and the weight in comparison with the conventional configuration. Moreover, it is possible to improve the supply of air to the stacks of individual cells in comparison to a solution with a manifold. Furthermore, this function can be improved by a higher power density of the system as a whole.

What is claimed is:

1. A system comprising:
a fuel cell; and
a heat exchanger coupled to the fuel cell, wherein the heat exchanger is arranged upstream of the fuel cell in a flow of gaseous reactants for the fuel cell for preheating gaseous reactants, wherein the heat exchanger is arranged downstream of the fuel cell in a flow of at least a portion of the waste gas from the fuel cell, and wherein the heat exchanger is directly integrated with the fuel cell so that there is a direct flow transition from the heat exchanger to the flow cell.

2. The system of claim 1, wherein the fuel cell is supplied essentially uniformly over a width of the fuel cell's stacks by the heat exchanger with the preheated gaseous reactants.

3. The system of claim 2, wherein the gaseous reactants include at least one of air and oxygen.

4. The system of claim 3, further comprising a burner that is integrated in the heat exchanger and designed as an afterburner for the reactants, which have not been consumed in the fuel cell.

5. The system of claim 4, wherein the heat exchanger includes a plate heat exchanger.

6. The system of claim 1, further comprising a burner that is integrated in the heat exchanger and designed as an afterburner for the reactants, which have not been consumed in the fuel cell.

7. The system of claim 1, wherein the heat exchanger includes a plate heat exchanger.

8. The system of claim 1, wherein the gaseous reactants include at least one of air and oxygen.

9. The system of claim 8, further comprising a burner that is integrated in the heat exchanger and designed as an afterburner for the reactants, which have not been consumed in the fuel cell.

10. The system of claim 9, wherein the heat exchanger includes a plate heat exchanger.

11. A method for making a system comprising the step of:
coupling a heat exchanger to a fuel cell by arranging the heat exchanger upstream of the fuel cell in a flow of gaseous reactants for the fuel cell for preheating gaseous reactants and arranging the heat exchanger downstream of the fuel cell in a flow of at least a portion of the waste gas from the fuel cell; and
directly integrating the heat exchanger with the fuel cell so that there is a direct flow transition from the heat exchanger to the flow cell.

12. The method of claim 11, further comprising the step of using the heat exchanger to supply the preheated gaseous reactants to the fuel cell essentially uniformly over a width of the fuel cell's stacks.

13. The method of claim 12, wherein the gaseous reactants include at least one of air and oxygen.

14. The method of claim 13, further comprising integrating a burner in the heat exchanger, wherein the burner is designed as an afterburner for the reactants, which have not been consumed in the fuel cell.

15. The method of claim 14, wherein the heat exchanger includes a plate heat exchanger.

16. The method of claim 11, further comprising integrating a burner in the heat exchanger, wherein the burner is designed as an afterburner for the reactants, which have not been consumed in the fuel cell.

17. The method of claim 11, wherein the heat exchanger includes a plate heat exchanger.

18. The method of claim 11, wherein the gaseous reactants include at least one of air and oxygen.

19. The method of claim 18, further comprising integrating a burner in the heat exchanger, wherein the burner is designed as an afterburner for the reactants, which have not been consumed in the fuel cell.

20. The method of claim 19, wherein the heat exchanger includes a plate heat exchanger.
